(19) United States
(12) Patent Application Publication
(10) Pub. No.: US 2024/0394710 A1
(43) Pub. Date: Nov. 28, 2024

(54) SYSTEMS AND METHODS FOR IDENTIFYING CHANGES IN CUSTOMER MUTABLE CHARACTERISTICS IN CUSTOMER IDENTITY DATA USING TRANSACTIONAL DATA

(71) Applicant: JPMORGAN CHASE BANK, N.A., New York, NY (US)

(72) Inventors: Reetu Raj BOK, Philadelphia, PA (US); Stefan SCHUBERT, Columbus, OH (US)

(21) Appl. No.: 18/671,463

(22) Filed: May 22, 2024

Related U.S. Application Data
(60) Provisional application No. 63/504,497, filed on May 26, 2023.

(51) Int. Cl. G06Q 20/40

(52) U.S. Cl. CPC G06Q 20/4014

(57) ABSTRACT

Systems and methods for identifying changes in customer mutable characteristics in customer identity data using transactional data are disclosed. According to an embodiment, a method may include: (1) receiving, by a computer program executed by an electronic device, a plurality of transactions conducted with a financial instrument issued to a customer; (2) extracting, by the computer program, metadata from one of the plurality of transactions; (3) retrieving, by the computer program, a plurality of stored mutable characteristics for the customer; (4) determining, by the computer program, that the metadata indicates a possible change in one of the plurality of stored mutable characteristics; (5) requesting, by the computer program, confirmation that the one stored mutable characteristic has changed; and (6) updating, by the computer program, the one stored mutable characteristic in response to receiving confirmation that the one stored mutable characteristic has changed.

### RELATED APPLICATIONS

This application claims priority to, and the benefit of, U.S. Provisional Patent Application Ser. No. 63/504,497, filed May 26, 2023, the disclosure of which is hereby incorporated, by reference, in its entirety.

### BACKGROUND OF THE INVENTION

### 1. Field of the Invention

Embodiments are generally directed to systems and methods for identifying changes in customer mutable characteristics in customer identity data using transactional data.

### 2. Description of the Related Art

Banks and other financial institutions are qualified owners of customer identity data. These organizations often use third party data sources and aggregators to verify customer identity data to meet regulatory requirements, mitigate fraud, maintain customer contact, and for other purposes. These aggregators, however, generally are not able to detect data that may no longer be valid, or to correlate or deepen a confidence in that data. And customers do not always update their addresses and other information. This often leads to outdated, or stale, customer information.

### SUMMARY OF THE INVENTION

Systems and methods for identifying changes in customer mutable characteristics in customer identity data using transactional data are disclosed. According to an embodiment, a method may include: (1) receiving, by a computer program executed by an electronic device, a plurality of transactions conducted with a financial instrument issued to a customer; (2) extracting, by the computer program, metadata from one of the plurality of transactions; (3) retrieving, by the computer program, a plurality of stored mutable characteristics for the customer; (4) determining, by the computer program, that the metadata indicates a possible change in one of the plurality of stored mutable characteristics; (5) requesting, by the computer program, confirmation that the one stored mutable characteristic has changed; and (6) updating, by the computer program, the one stored mutable characteristic in response to receiving confirmation that the one stored mutable characteristic has changed.

In one embodiment, the stored mutable characteristics comprise a home address, a phone number, a marital status, a surname, a family status, or an employment status.

In one embodiment, the step of determining, by the computer program, that the metadata indicates a possible change in one of the plurality of stored mutable characteristics may include: identifying, by the computer program, a mutable characteristic in the metadata that differs from the one stored mutable characteristic.

In one embodiment, the method may also include determining, by the computer program, a confidence level in the possible change in the one stored mutable characteristic. In one embodiment, the confidence level may be determined using a trained machine learning engine.

In one embodiment, at least one of the plurality of transactions may be a card present transaction.

In one embodiment, a threshold number of transactions having changes in the one stored mutable characteristic before requesting confirmation from the customer.

In one embodiment, the transactions are associated with good or service associated with a change in the one stored mutable characteristic.

In one embodiment, the good or service may be associated with a move to a new area, a change in family status, etc.

In one embodiment, the method may also include receiving, by the computer program, geolocations for customer access to a computer application executed by a mobile electronic device associated with the customer. The computer program further determines the possible change in the one stored mutable characteristic based on the geolocations.

According to another embodiment, a non-transitory computer readable storage medium may include instructions stored thereon, which when read and executed by one or more computer processors, cause the one or more computer processors to perform steps comprising: receiving a plurality of transactions conducted with a financial instrument issued to a customer; extracting metadata from one of the plurality of transactions; retrieving a plurality of stored mutable characteristics for the customer; determining that the metadata indicates a possible change in one of the plurality of stored mutable characteristics; requesting confirmation that the one stored mutable characteristic has changed; and updating the one stored mutable characteristic in response to receiving confirmation that the one stored mutable characteristic has changed.

In one embodiment, the stored mutable characteristics comprise a home address, a phone number, a marital status, a surname, a family status, or an employment status.

In one embodiment, the metadata indicates a possible change in the one stored mutable characteristic when a mutable characteristic in the metadata differs from the one stored mutable characteristic.

In one embodiment, the non-transitory computer readable storage medium may also have instructions stored thereon, which when read and executed by the one or more computer processors, cause the one or more computer processors to perform steps comprising: determining a confidence level in the possible change. In one embodiment, the confidence level may be determined using a trained machine learning engine.

In one embodiment, at least one of the plurality of transactions may be a card present transaction.

In one embodiment, a threshold number of transactions having changes in the one stored mutable characteristic before requesting confirmation from the customer.

In one embodiment, the transactions are associated with good or service associated with a change in the one stored mutable characteristic, and the good or service may be associated with a move to a new area or a change in family status.

In one embodiment, the non-transitory computer readable storage medium may also include instructions stored thereon, which when read and executed by the one or more computer processors, cause the one or more computer processors to perform steps comprising: receiving geolocations for customer access to a computer application executed by a mobile electronic device associated with the customer; and determining a possible change in the one stored mutable characteristic based on the geolocations.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for identifying changes in customer mutable characteristics in customer identity data using transactional data according to an embodiment;

FIG. 2 illustrates a method for identifying changes in customer mutable characteristics in customer identity data using transactional data according to an embodiment;

FIG. 3 illustrates a block diagram of a technology infrastructure and computing device for implementing certain embodiments of the present disclosure.

### DETAILED DESCRIPTION OF PREFERRED EMBODIMENTS

Systems and methods for identifying changes in customer mutable characteristics in customer identity data using transactional data are disclosed. Embodiments address, for example, problems with having outdated customer information.

Financial institutions, such as banks, are uniquely positioned to use customer's transaction and banking behavior to detect mutable identity data that may no longer be valid, or to offer additional correlation to existing data to improve confidence in that data. Embodiments may not detect a specific attribute (e.g., a specific address, a phone number, etc.), but may instead identify changes that require specific updates, or add confidence to specific data.

For example, a shift in data may indicate a need for an update; consistent data may indicate confidence in the accuracy or strength of the data.

In one embodiment, transactional data, such as point of sale (POS) geo-location data from debit and credit card transactions may be used to correlate a customer's address, or to detect a potential change in the customer's address. For example, if a customer's address is in Chicago with a history of POS transactions in Chicago, there may be additional confidence the customer's address data is correct. If, however, the POS transactions migrated for an extended period of time to New York, this may indicate the customer has moved.

In one embodiment, once a confidence in an address change has been reached, which may be based on machine learning, the customer may be prompted to confirm the customer's address. The customer address of record may not be changed until confirmation of an address change is received from the customer.

In another embodiment, POS merchant categorization may also be used to indicate a potential change in address. By reviewing certain types of merchant spending, embodiments may identify indications that a customer may have moved or be in the process of moving. For example, a purchase from a real estate title agency, real estate appraisers, etc. coupled with large furniture store purchases may indicate that the customer has purchased a new home, which may trigger a request to update the customer's address information.

In another embodiment, changes in transactions, such as bill-payments to utility providers, may indicate a move or change in address. For example, changing electric, gas and internet providers/accounts within a short period of time may indicate a change in address.

In another embodiment, comparing providers to other customer subsets may indicate a specific region to which a customer has moved by focusing on regional providers.

In another embodiment, large money movement transactions, such as wires or large checks, to specific recipients (e.g., title agencies, rental agencies, etc.) may indicate a move.

In another embodiment, large purchases at phone stores or similar changes in monthly payments to phone providers may be indicators of a change to the customer's phone number.

In another embodiment, geolocation data from logins to an application (e.g., a banking application) that shift over a certain period of time may be used to indicate that the customer has moved.

In another embodiment, inbound phone number or Automated Number Indicator (ANI) tracking may be used to indicate a change in a customer's phone number.

In embodiments, changes in spending can indicate changes in a customer's identity that are not typically captured data attributes, but are still useful in building an identity profile for that customer: Examples include a change in direct deposit amount or source may indicate a new employment or professional change; large purchases at a wedding venue may indicate a change in marital status; ongoing large purchases at children's or baby related stores may indicate a child birth or a transition to parenthood.

In embodiments, a statistical model may be used to ingest data and provide meaningful indicators. Within a model, there may be distinct groupings of outcomes. First, embodiments may detect a possible change in identity information. By beginning with a historical population of customers who eventually had changes in identity attributes, embodiments may consider the transactional and behavioral data leading up to those changes to identify common changes in spending patterns that would indicate a change is about to take place.

For example, the model may receive transaction data (e.g., point of sale purchases), online banking transaction data (e.g., utility bill payments), customer behavior (e.g., locations of logins to mobile applications, visits to banking branches, etc.), etc. and may use these inputs to determine the likelihood of a change in a mutable characteristic, such as an address. The model may use statistics, such as a number of transactions from outside of a home location, a number of logins from outside of a home location, locations of utility providers, types of transactions (e.g., hardware stores), to make this assessment.

Data output from the model may be indicative of an upcoming change in identity information. The output may also be compared to external data sources historically to determine how early it may predict later changes to identity data.

For example, the outcome may be a numerical or statistical value indicating that a specific mutable characteristic may no longer be valid and may need to be updated, or it may be a numerical or statistical value creating confidence that an identity attribute is valid and can be trusted.

In addition, embodiments may strengthen or correlate existing identity information. By beginning with a historical population of customers who, after aging and verification, had no changes in identity attributes, embodiments may consider what transactional and behavioral data may reinforce the accuracy of the identity. This functions as a positive confidence indicator in the identity data that is available.

Embodiments may also create customer populations that may be predictive of a general outcome of identity attribute changes for members of that population. By creating populations of customers based on common identity factors (e.g., address, phone provider, common employment or profession, etc.), embodiments may create cohorts of data to compare members of the populations. By establishing common behavioral and spending baselines for these cohorts, embodiments may predict general but not specific outcomes for upcoming changes in identity data. For example, embodiments may predict a customer will soon change its address to a certain metro area, but would not know the exact address.

The outcome may be a segmentation of users into populations predicting an identity attribute may no longer be valid, and a general prediction of how that attribute may be changing.

By using transactional data that is available to financial institutions, embodiments may create value in predicting identity changes or adding correlation and strength to identity attributes. For example, this information may be used to update downstream systems that may use customer address information, such as fraud systems, mailing systems (e.g., to mail bank statements, replacement credit cards), sensitive correspondence, etc. Thus, if there is a low confidence in a customer's address of record, the downstream systems may not use mail to communicate with the customer until the customer verifies or updates the customer's address.

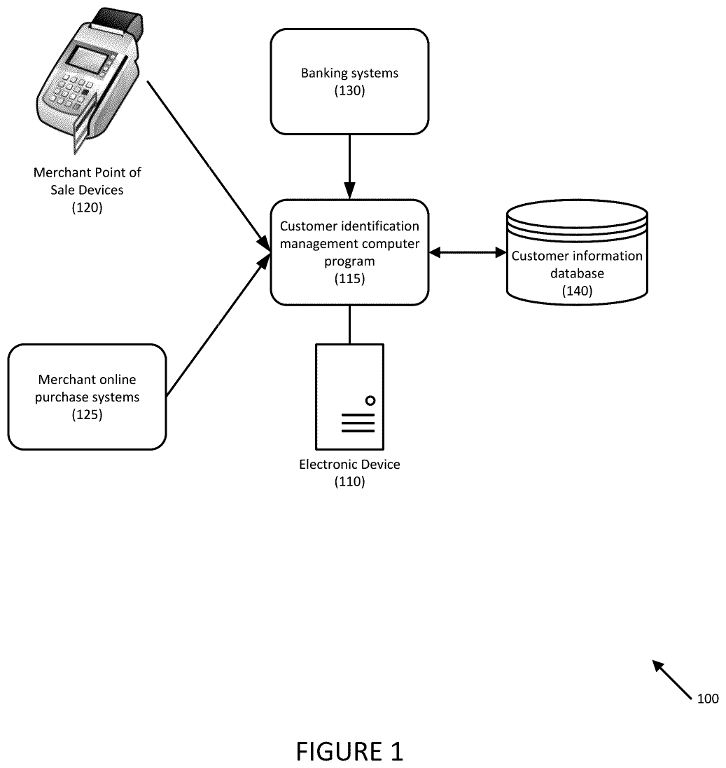

Referring to FIG. 1, a system for identifying changes in customer mutable characteristics in customer identity data using transactional data is disclosed according to an embodiment. System 100 may include electronic device 110, which may be a server (e.g., physical and/or cloud-based), a computer (e.g., a workstation, a desktop, a laptop, a notebook, a tablet, etc.), etc. Electronic device 110 may execute customer information management computer program 115, which may receive transaction data (e.g., credit card and debit card) transactions from merchant point of sale devices 120 and/or merchant online purchase systems 125. Customer information management computer program 115 may also receive data from banking systems 130, such as credit card systems, check processing systems, online bill pay systems, loan systems (e.g., mortgage, auto, etc.).

Customer information management computer program 115 may leverage the data received from merchant point of sale devices 120, merchant online purchase systems 125, and/or banking systems 130 in order to identify a possibility of a mutable customer characteristic changing. Examples of mutable customer characteristics may include home address, phone number, marital status, surname, family status (e.g., children, pets, etc.), employment status, etc. In one embodiment, customer information management computer program 115 may identify metadata, such as merchant information, purchase information, geolocation information, etc., from transactions received from merchant point of sale devices 120, merchant online purchase systems 125, and/or banking systems 130 and may compare it to customer information in customer information database 140. If the metadata indicates a change in customer information (e.g., address, phone number, marital status, family status, etc.), customer information management computer program 115 may send a communication to the customer to confirm the information in question or provide updated information. The customer's information of record may not be updated until the customer confirms a change.

In one embodiment, before the communication is sent, a threshold (e.g., a number of transactions, a period of time, etc.) may be required to be met before sending the message so that the customer is not sent communications while travelling, on vacation, etc.

In one embodiment, if the metadata is consistent with the contact information, confidence in the contact information may optionally be recorded, for example, in customer information database 140.

In one embodiment, if the metadata indicates a life change (e.g., transactions with a title service, purchases at wedding provider, purchases at baby stores), customer information management computer program 115 may request confirmation of homeowner status, marriage status, family status, etc.

In one embodiment, in response to changes, targeted communications may be generated and provided to the customer. In embodiments, the targeted communication may be from partner of the bank. Examples of such communications may include lines of credit, insurance, etc.

In one embodiment, customer information management computer program 115 may use a trained machine learning engine to determine whether a change is likely to indicate a change in the customer information. For example, the trained machine learning engine may be trained with historical data from customers in order to predict a likelihood that a difference is indicative of a change in one or more mutable customer characteristics.

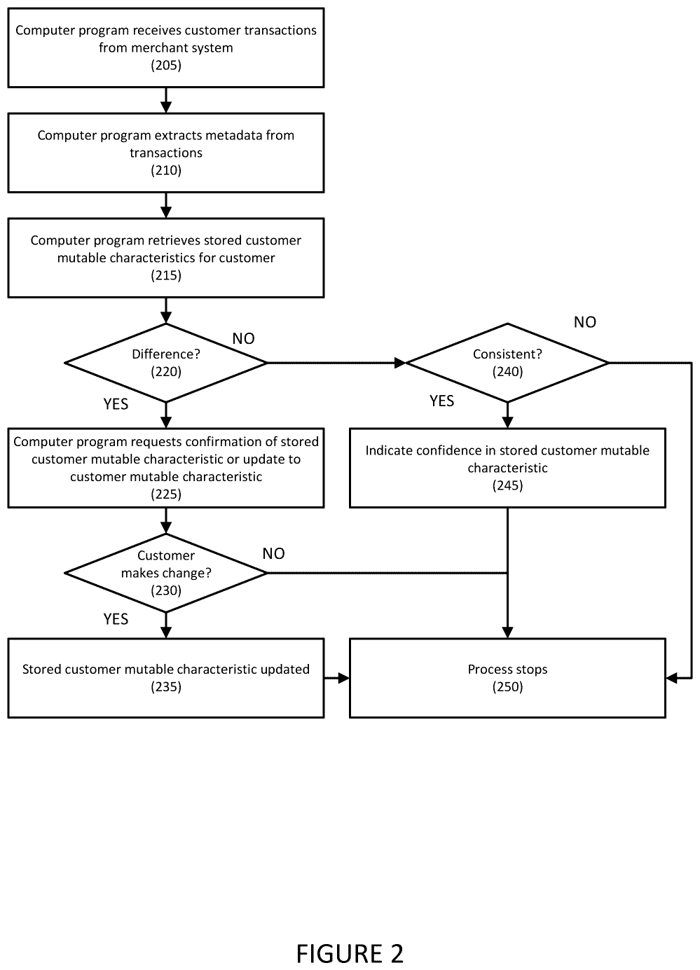

Referring to FIG. 2, a method for identifying changes in customer mutable characteristics in customer identity data using transactional data is disclosed according to an embodiment.

In step 205, a computer program may receive customer transactions from a merchant system. For example, the customer transaction may be received from a point-of-sale device, an online sales system, etc. In addition, the transaction may be received from a banking system.

In one embodiment, the transactions may be conducted using a financial instrument, such as a credit card, a debit card, etc. issued to a customer.

In step 210, the computer program may extract metadata from the customer transactions. For example, the computer program may extract merchant information (e.g., merchant category code, or MCC), product information, a transaction geolocation, whether the transaction was in person or not, etc.

In one embodiment, embodiments may give transactions made when the card was present a higher weighting than transactions where the card was not present.

In step 215, the computer program may retrieve stored customer information for the customer. For example, the computer program may retrieve stored mutable customer characteristics, such as the customer's address information, phone number, marital status, family status, etc.

In step 220, the computer program may compare the metadata to the retrieved information to determine if there is a possibility that one of the customer mutable characteristics is likely to have changed. For example, the computer program may compare the customer address to the geolocation of the transaction to see if the locations differ.

In one embodiment, the computer program may use a trained machine learning engine to determine whether a change is likely to indicate a change in a customer mutable characteristic. For example, the trained machine learning engine may be trained with historical data from customers in order to predict a likelihood that a difference is indicative of a change. Embodiments may train the machine learning engine based on customer characteristics such as age, gender, etc.

In one embodiment, before identifying a possible change, the difference may have to meet a threshold, such as a number of transactions, a period of time over which the transactions occur, a number of different merchants, etc.

If the computer program identifies a difference, in step 225, the computer program may send a communication to the customer to request confirmation of the stored customer mutable characteristic (i.e., not change to the mutable characteristic), or an update the customer mutable characteristic. The communication may be sent by a channel that is not identified as potentially changing.

In step 230, if the customer makes a change, in step 235, the stored customer mutable characteristic is updated. If the customer does not make a change, the system may continue to monitor transactions. In one embodiment, the difference that led to the communication may be added to a list of differences to ignore in the future so that the same difference does not trigger another communication.

If, in step 220, there was not a difference, the computer program may optionally determine, in step 240, if the metadata increases confidence in certain customer mutable characteristics (e.g., the transaction is near the customer's home address of record). If so, in step 245, the computer program may indicate confidence in the stored customer mutable characteristic in the customer information database. For example, the computer program may indicate that the stored mutable characteristic was consistent with received transaction metadata. In one embodiment, a count of transactions with metadata that is consistent with stored customer mutable characteristics may be maintained.

If not, the process may stop in step 250.

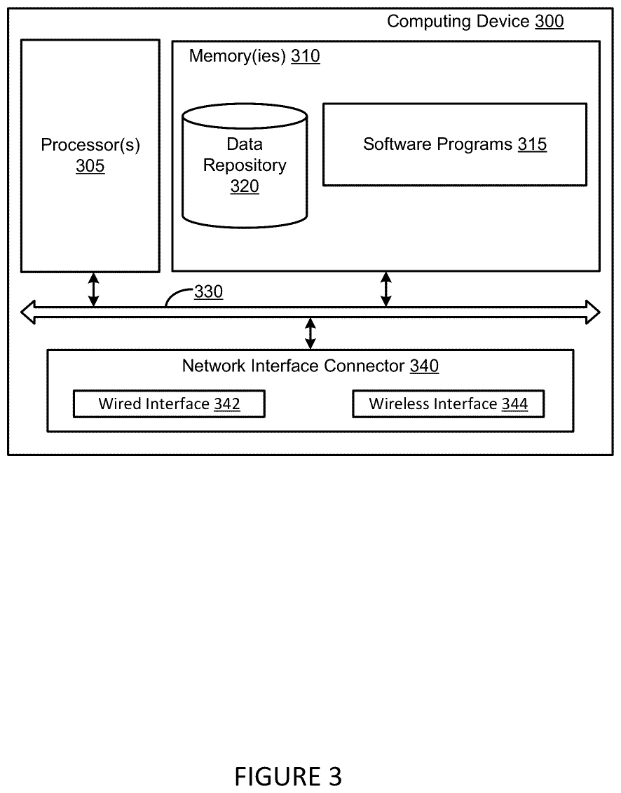

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

The disclosure of U.S. patent application Ser. No. 17/901,056 is hereby incorporated, by reference, in its entirety.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
receiving, by a computer program executed by an electronic device, a plurality of transactions conducted with a financial instrument issued to a customer;
extracting, by the computer program, metadata from one of the plurality of transactions;
retrieving, by the computer program, a plurality of stored mutable characteristics for the customer;
determining, by the computer program, that the metadata indicates a possible change in one of the plurality of stored mutable characteristics;
requesting, by the computer program, confirmation that the one stored mutable characteristic has changed; and
updating, by the computer program, the one stored mutable characteristic in response to receiving confirmation that the one stored mutable characteristic has changed.

2. The method of claim 1, wherein the stored mutable characteristics comprise a home address, a phone number, a marital status, a surname, a family status, or an employment status.

3. The method of claim 1, wherein the step of determining, by the computer program, that the metadata indicates a possible change in one of the plurality of stored mutable characteristics comprises:
identifying, by the computer program, a mutable characteristic in the metadata that differs from the one stored mutable characteristic.

4. The method of claim 1, further comprising:
determining, by the computer program, a confidence level in the possible change in the one stored mutable characteristic.

5. The method of claim 4, wherein the confidence level is determined using a trained machine learning engine.

6. The method of claim 1, wherein at least one of the plurality of transactions is a card present transaction.

7. The method of claim 1, wherein a threshold number of transactions having changes in the one stored mutable characteristic before requesting confirmation from the customer.

8. The method of claim 1, wherein the transactions that are associated with good or service are associated with a change in the one stored mutable characteristic.

9. The method of claim 8, wherein the good or service is associated with a move to a new area.

10. The method of claim 8, wherein the good or service is associated with a change in family status.

11. The method of claim 1, further comprising:
receiving, by the computer program, geolocations for customer access to a computer application executed by a mobile electronic device associated with the customer;
wherein the computer program further determines the possible change in the one stored mutable characteristic based on the geolocations.

12. A non-transitory computer readable storage medium, including instructions stored thereon, which when read and executed by one or more computer processors, cause the one or more computer processors to perform steps comprising:
receiving a plurality of transactions conducted with a financial instrument issued to a customer;
extracting metadata from one of the plurality of transactions;
retrieving a plurality of stored mutable characteristics for the customer;
determining that the metadata indicates a possible change in one of the plurality of stored mutable characteristics;
requesting confirmation that the one stored mutable characteristic has changed; and
updating the one stored mutable characteristic in response to receiving confirmation that the one stored mutable characteristic has changed.

13. The non-transitory computer readable storage medium of claim 12, wherein the stored mutable characteristics comprise a home address, a phone number, a marital status, a surname, a family status, or an employment status.

14. The non-transitory computer readable storage medium of claim 12, wherein the metadata indicates a possible change in the one stored mutable characteristic when a mutable characteristic in the metadata that differs from the one stored mutable characteristic.

15. The non-transitory computer readable storage medium of claim 14, further including instructions stored thereon, which when read and executed by the one or more computer processors, cause the one or more computer processors to perform steps comprising:
determining a confidence level in the possible change.

16. The non-transitory computer readable storage medium of claim 15, wherein the confidence level is determined using a trained machine learning engine.

17. The non-transitory computer readable storage medium of claim 12, wherein at least one of the plurality of transactions is a card present transaction.

18. The non-transitory computer readable storage medium of claim 12, wherein a threshold number of transactions having changes in the one stored mutable characteristic before requesting confirmation from the customer.

19. The non-transitory computer readable storage medium of claim 12, wherein the transactions that are associated with good or service are associated with a change in the one stored mutable characteristic, and the good or service is associated with a move to a new area or a change in family status.

20. The non-transitory computer readable storage medium of claim 12, further including instructions stored thereon, which when read and executed by the one or more computer processors, cause the one or more computer processors to perform steps comprising:
receiving geolocations for customer access to a computer application executed by a mobile electronic device associated with the customer; and
determining a possible change in the one stored mutable characteristic based on the geolocations.
